(19) United States
(12) Patent Application Publication
(10) Pub. No.: US 2015/0354991 A1
(43) Pub. Date: Dec. 10, 2015

(54) COIL ARRANGEMENT HAVING TWO COILS

(71) Applicant: ZF FRIEDRICHSHAFEN AG, Friedrichshafen (DE)

(72) Inventors: Alexander GRAF, Friedrichshafen (DE); Florian WEINL, Lindau (DE); Michael PANTKE, Friedrichshafen (DE)

(73) Assignee: ZF FRIEDRICHSHAFEN AG, Friedrichshafen (DE)

(21) Appl. No.: 14/759,432

(22) PCT Filed: Dec. 17, 2013
(86) PCT No.: PCT/EP2013/076833

§ 371 Date: Jul. 7, 2015

(30) Foreign Application Priority Data
Jan. 18, 2013 (DE) 10 2013 200 698.5

(51) Int. Cl. G01D 5/20; H01F 5/04; H01F 41/06

(52) U.S. Cl. CPC G01D 5/2046; H01F 41/06; H01F 5/04

(57) ABSTRACT

A cod arrangement, in particular for a position sensor, has a first coil (1) and a second coil (2) which are electrically connected to one another and disposed substantially coaxially relative to one another. The first coil (1) has a winding density that increases in the longitudinal direction (X) of the coil arrangement, and the second coil (2) has a winding density that decreases in the longitudinal direction (X) of the coil arrangement. In addition, the invention relates to a position sensor having such a coil arrangement and a production method for such a coil arrangement.

This application is a National Stage completion of PCT/EP2013/076833 filed Dec. 17, 2013, which claims priority from German patent application serial no. 10 2013 200 698.5 filed Jan. 18, 2013.

### FIELD OF THE INVENTION

The invention relates to a coil arrangement having a first coil and a second coil, which are electrically connected to one another, and which are disposed substantially coaxially relative to one another, wherein the first coil has a winding density that increases in the longitudinal direction of the coil arrangement. Furthermore, the invention relates to a position sensor, as well as to a production method for the coil arrangement.

### BACKGROUND OF THE INVENTION

Various embodiments of contactless linear position sensors are known. The most important representatives use magnetic fields for sensing. These include sensors that use the Hall effect or the law of induction. The latter, in turn, can be subdivided into two groups according to the principle by which such sensors operate. Both have in common an arrangement of coils and a transducer element, which, in the first group, must be electrically conductive, and in the second group, must be a soft magnetic material.

The first group, eddy current sensors, uses induction to create an opposing field in an electrically conductive material, which dampens the excitation field. The transducer element is used to modify the damping ratio in proportion to the travel. The energy needed in order to still maintain the excitation field can be used as a measured variable. In so doing, the element that indicates the travel (transducer element) does not enter the coil.

The second group differs therefrom in that the magnetic field in the coil is directly influenced by the soft magnetic transducer element. In this case, the inductance of the coil is measured, wherein there are different methods used to do so. In the case of a moving coil sensor, position sensing is based on the use of the relative permeability of soft magnetic iron and the associated fact that the inductance of a coil is proportional to the relative permeability of the coil core. As such, the coil core is used as an element that indicates travel, which results in a change in the inductance and thus, in a measured variable that is proportional to the travel. To this end, simple linear coils or simple coils in a plurality of chambers are used in order to influence the sensitivity. Sensors that function according to the LVDT (Linear Variable Differential Transformer) or PLOD (Permanent-magnetic Linear Contactless Displacement) principle can be described as a differential transformer. Here, a primary coil and two secondary coils are used, wherein the coils are disposed along the pathway that is to be sensed. The long primary coil is located in the middle, between the short secondary coils at the two ends of the sensor. All three coils are located on a soft magnetic rod, which is disposed parallel to the measuring path. The field distribution of the primary coil on the secondary coils can be influenced with the help of a magnet, which serves as a transducer element.

A disadvantage to these known sensors is that they have a very complex design. By contrast, the position sensor or, respectively, the coil arrangement on which the sensor is based, which is described in DE 38 01 779 C2, has a simple design and essentially only requires two coaxial coils having a magnetically conductive transducer element, which can be moved within the coils. Here, one of the coils has a winding density that can be varied in the longitudinal direction,

It has been found that a position sensor having such a design is not suitable for precise applications, since such a sensor has insufficient measurement accuracy.

### SUMMARY OF THE INVENTION

The object of the invention is, therefore, to provide a coil arrangement, by means of which a highly precise position sensor can be implemented. In addition, the object of the invention is also to provide such a sensor, as well as a production method for such a coil arrangement. This object is achieved by a coil arrangement, a position sensor and a production method having the features described below.

Accordingly, the invention relates to a coil arrangement, in particular for a position sensor. The coil arrangement has a first coil and a second coil, which are electrically connected to one another, and which are disposed substantially coaxially relative to one another, wherein the first coil has a winding density that increases in the longitudinal direction of the coil arrangement. Furthermore, the second coil has a winding density that decreases in the longitudinal direction of the coil arrangement.

Accordingly, the winding density of the first winding increases in the longitudinal direction of the coil arrangement, while at the same time, the winding density of the second winding decreases in this longitudinal direction. The winding densities of the coils thus develop in reverse of one another in the longitudinal direction of the coils. As a result, the second coil no longer functions merely as a reference coil for the first coil, but instead, the inductance of the second coil is now also a function of the position of a magnetically conductive transducer element when the coil arrangement is used in a position sensor having such a transducer element. Thus, there is a significant improvement in the measurement resolution of the position sensor or, respectively, of the coil arrangement, and a highly precise position sensor can be implemented by means of this coil arrangement. Here, the winding density is understood, in particular, to refer to the number of windings per unit of length in the longitudinal direction of the coil arrangement.

A change in the winding density is brought about, in particular, by an increase or, respectively, decrease in the radial number of winding layers. Thus, the fill factor of the coils in the longitudinal direction of the coil arrangement remains constant, whereby a consistently good measurement resolution of the position sensor or, respectively, of the coil arrangement in the longitudinal direction is brought about In particular, the coils are each wound orthocyclically, whereby an especially good fill factor can be achieved. In addition, it is especially preferred that the coils have the opposite winding direction. In this way, the coils each establish a magnetic field, one influencing the other, when supplied with electrical current.

The distribution of the electrical voltage within the coil arrangement when the coil arrangement is supplied with electrical current is a function of the resistive and inductive component of the coils. A magnetically conductive transducer element, which is allocated to the coils, thus has a substantial influence on the inductance of the individual coils, wherein this influence exerted by the winding density, which changes along the longitudinal direction of the coil, is a function of the position of the transducer element. Thus, it is possible to extrapolate the position of the transducer element with respect to the coil arrangement by assessing the voltage difference between the two coils of the coil arrangement.

In one preferred embodiment, the winding density of the first coil increases in the longitudinal direction of the coil arrangement essentially to the same extent that the winding density of the second coil decreases. Thus, although the winding density of each individual coil changes, the total winding density remains constant. As a result, the coil arrangement can have a very compact design, with a constant outer diameter in the longitudinal direction.

In a further preferred embodiment, the winding density of the first and second coils changes in a linear manner. In so doing, the linear change may only exist within a longitudinal section of the coil arrangement in the longitudinal direction, or may extend over the entire length of the coil arrangement in the longitudinal direction. In the case of a linear change in the winding density, the inductance is essentially a linear function of the position of a magnetically conductive transducer element with respect to the coil arrangement, whereby it is then particularly easy to extrapolate the position of the transducer element with respect to the coil arrangement from the inductance of the coil arrangement.

In a further preferred embodiment, the winding density of the first and second coil changes abruptly by sections. In other words, the coil arrangement has at least two longitudinal sections in the longitudinal direction of the coil, which sections have different winding densities on the directly adjacent sides thereof. As a result, the inductance of the coil arrangement changes abruptly when a magnetically conductive transducer element is moved from one of the longitudinal sections into another of the longitudinal sections with respect to the coil arrangement. This abrupt change in the inductance can be very clearly detected, as a result of which it is possible to very clearly and precisely determine the position of the transducer element when the transducer passes the change in density, i.e., the transition between the longitudinal sections. Thus, in particular, one or a plurality of reference points can be marked along the longitudinal direction of the coil by means of one or a plurality of transitions between two directly consecutive longitudinal sections having different winding densities. Moreover, several or, respectively, a plurality of longitudinal sections may be provided having winding densities that vary from one another, which bring about an incremental change in the winding density in the longitudinal direction of the coil. As a result, the position of the magnetically conductive transducer element with respect to the coil arrangement can be clearly, incrementally detected. The more longitudinal sections of this kind are present, the more precisely the position of the transducer element in the longitudinal direction can be incrementally detected.

In a further preferred embodiment, the winding density of the first and second coil changes in a first longitudinal section of the coil arrangement, wherein this change is, in particular, linear. In a second longitudinal section that adjoins the first section, the winding density of the first and second coil is constant. In a third section that directly adjoins the second section, the winding density of the first and second coil changes, wherein this change is, in particular, linear. This results in a coil arrangement having a high degree of measuring sensitivity and easy interpretability in the first and third longitudinal section, while resulting in a relatively low measuring sensitivity in the second longitudinal section. This is then, in particular, a longitudinal section, within which no precise measurement is required. Such a design of the coil arrangement also makes it possible to linearize the sensor characteristics when using the coil arrangement in a position sensor.

In a further preferred embodiment, the two coils are electrically connected in series, one directly after the other, with a measuring tap between the coils. Thus, the structure of the coil arrangement is particularly simple. Here, the coils form a voltage divider.

In an alternative, further preferred embodiment, the two coils are each connected in series to a comparator resistor, wherein each of the coils, together with the respective comparator resistor connected in series, forms a leg of a Wheatstone bridge circuit. As such, a measuring tap is provided between each of the coils and comparator resistor connected thereto in series. The two coils are thus electrically connected to one another in parallel, wherein each of the coils is electrically connected to the comparator resistor in series. As a result, it is possible to precisely assess the position of a magnetically conductive transducer element, which is allocated to the coil arrangement.

In a further preferred embodiment, a magnetically conductive housing is provided, for example made of a ferromagnetic material, within which the coils are disposed in order to magnetically influence the magnetic flux within the coil arrangement. A transformer effect within the coil arrangement is hereby amplified by the magnetic influence of the housing (increased magnetic flux within the coil arrangement) and therefore, the sensitivity of the coil arrangement is increased when used in a position sensor.

The position sensor according to the invention has a coil arrangement according to the invention as described above, as well as a magnetically conductive transducer element, which is disposed such that the element can be moved along the longitudinal direction of the coil arrangement as a position feedback transducer. The transducer element may thus be disposed either in an internal space in the coil arrangement such that the transducer element can be moved along the longitudinal direction of the coil, in particular coaxially to the coil arrangement, or alternatively, may be disposed about an exterior of the coil arrangement such that the transducer element can be moved along the longitudinal direction of the coil, in particular coaxially to the coil arrangement, thus annularly enclosing the coil arrangement.

By appropriately supplying electrical current to at least one of the coils of the coil arrangement, a magnetic force can also be generated on the transducer element in the longitudinal direction of the coil arrangement, whereby the position sensor can also be used as an actuator, and thus can be alternatively referred to as such. This force can be tapped on the transducer element and can be used to manipulate devices such as the switch elements of a motor vehicle transmission or of valves, for example. The force that is generated can be increased and influenced by providing a magnet yoke. In particular, the shape of the magnet yoke may be such that the position sensor forms a so-called proportional solenoid.

In a preferred embodiment of the position sensor, in the longitudinal direction, the coil arrangement is designed at least as circular segments, wherein the transducer element can be moved as an angle-position transducer along the longitudinal direction of the coil arrangement at least in circular segments, so that the position sensor forms an angle-position sensor. Alternatively, the coil arrangement is designed such that it is straight in the longitudinal direction, wherein the transducer element can be moved in a linear manner along the longitudinal axis of the coil arrangement as a linear position feedback transducer, so that the position sensor forms a linear position sensor.

It is especially preferred that the coil arrangement be energized with one or a plurality of voltage pulses in order to determine the position of the transducer element. The step response of the coil arrangement (current and/or voltage characteristic) is then subsequently assessed, and the position of the transducer element determined therefrom. The step response of the coil arrangement is a function of the position of the transducer element, since the transducer element influences the inductance of both coils. Since, in the design of the coil arrangement according to the invention, both coils have winding densities that change in the opposite direction, the change in the step response as a function of the position of the transducer element is particularly pronounced, whereby it is possible to assess the position of the transducer element with respect to the coil arrangement with particular precision.

The methods disclosed in Applicant's DE 102005018012 A1 and DE 102008043340 A1 and DE 102011083007 A1 have proven to be particularly preferred methods for controlling the position sensor or, respectively, determining the position of the transducer element in the position sensor.

The production method according to the invention for the above-mentioned coil arrangement according to the invention is characterized by a first production step, in which the first, radially inner coil is wound, and by a second production step, in which the second, radially outer coil is wound, and by a third production step, in which the first coil is electrically connected to the second coil. The production steps are preferably carried out staggered in time in this way. This production method results in an especially simple and cost-effective production of the coil arrangement. In the second production step, the winding of the second coil is preferably done in such a way that the opposite ends of the winding layers of the first and second coil are directly in contact with one another. In this way, gaps in the coil arrangement are avoided and the fill factor for the entire coil arrangement is optimized.

### BRIEF DESCRIPTION OF THE DRAWINGS

The invention is described in greater detail in the following on the basis of the figures, which depict preferred embodiments of the invention. Shown in each in a schematic representation are:

FIG. 1, a first preferred embodiment of the coil arrangement;

FIG. 2, a second preferred embodiment of the coil arrangement;

FIG. 3, a third preferred embodiment of the coil arrangement;

FIG. 4, a preferred embodiment of the coil arrangement having a housing;

FIG. 5, a first preferred electrical interconnection of the coil arrangement;

FIG. 6, a second preferred electrical interconnection of the coil arrangement;

FIG. 7a-c, preferred control method of the coil arrangement;

FIG. 8a-c, preferred production steps for producing a coil arrangement.

### DETAILED DESCRIPTION OF THE PREFERRED EMBODIMENTS

In the Figures, the same components, or at least those components having the same function, are provided with the same reference characters.

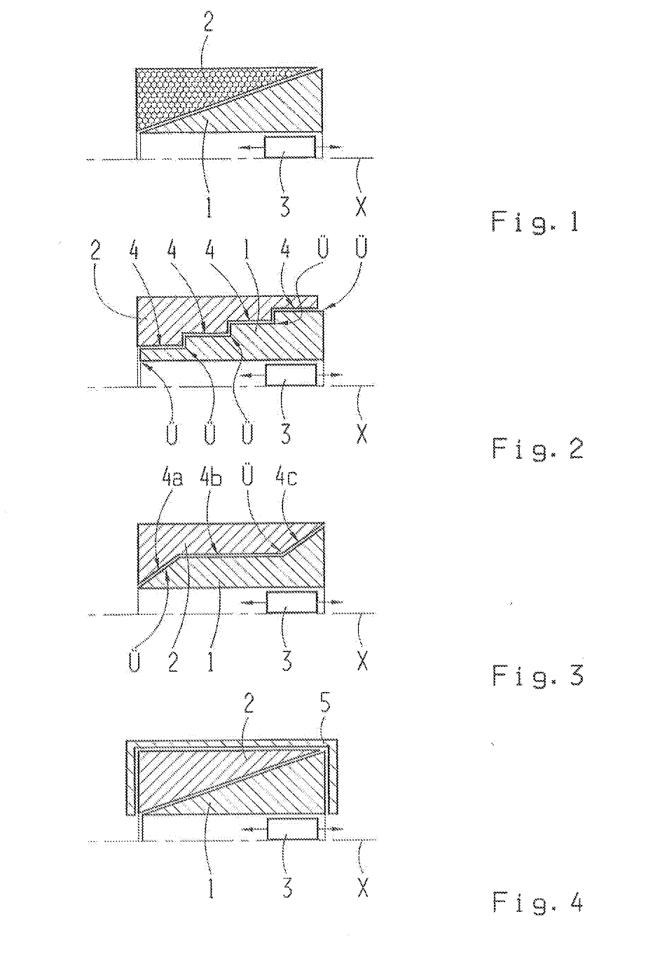

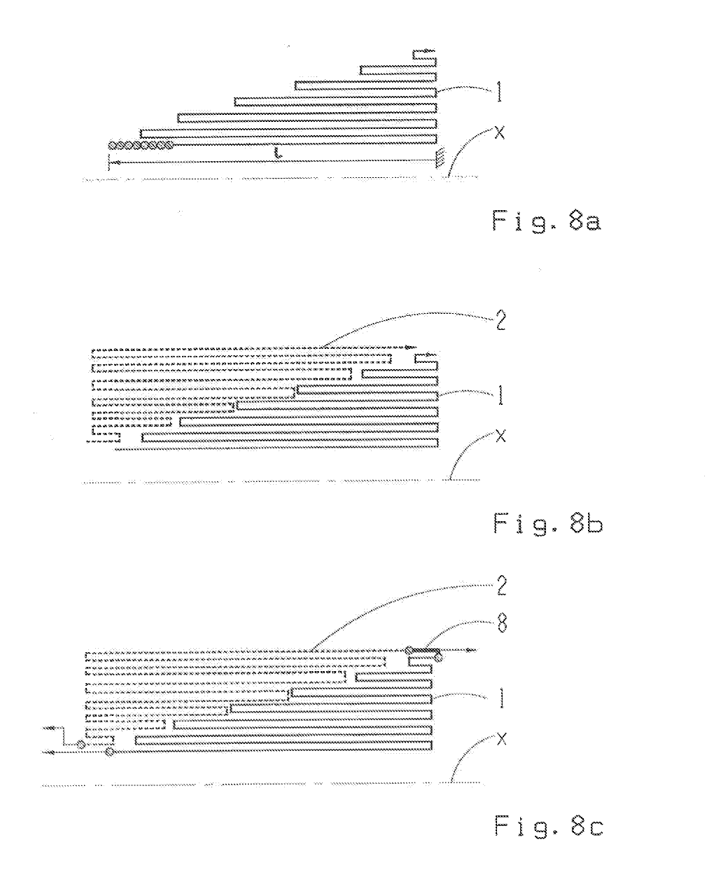

FIGS. 1, 2 and 3 each show a longitudinal section along the coil longitudinal direction X of the coil arrangement having a first coil 1 and a second coil 2. For the sake of clarity, the lower half of the coils 1, 2 is not depicted. The coil longitudinal direction X preferably simultaneously forms an axis of symmetry of the coil arrangement. The coils 1, 2 thus form a common hollow cylinder about the coil longitudinal direction X. The first coil 1 forms a radially inner coil, while the second coil 2 forms a radially outer coil. The coils 1, 2 are thus disposed in one another, substantially coaxially to the coil longitudinal direction X. The individual windings of the coil 2 are depicted in the second coil 2 by way of example. The windings run orthogonally with respect to the drawing plane of the Figures. As shown, the windings of the coils 1, 2 are preferably disposed orthocyclically with respect to one another in order to maximize the fill factor of the coils 1, 2. It can also be seen herefrom that the coils 1, 2 comprise a plurality of radial layers of windings. The steps for the preferred production of the coil arrangement can be found in FIG. 8a-c and the associated description.

A magnetically conductive transducer element, which is allocated to the coils 1, 2, is designated with the reference character 3. The transducer element 3 is designed such that it can be moved along the coil longitudinal direction X. Since the transducer element is designed such that it is magnetically conductive, the element influences the inductance of the two coils 1, 2. To this end, the transducer element 3 is made of soft iron or another ferromagnetic material, for example. Together with the coil arrangement, a position sensor is thus obtained, by means of which it is possible to determine a position of the transducer element 3 with respect to the coil arrangement, in particular a position along the coil longitudinal direction X. In the case shown, the transducer element 3 is disposed in an internal space in the coils 1, 2 substantially coaxially thereto. Alternatively, the transducer element may be disposed such that it annularly encloses an exterior of the coils 1, 2, substantially coaxially thereto.

The first coil 1 has a winding density that increases in the coil longitudinal direction X (as viewed from left to right). The second coil 2 in the coil longitudinal direction X, on the other hand, has a winding density that decreases in the coil longitudinal direction X (as viewed from left to right). Here, winding density is understood to be the number of windings per unit of length in the coil longitudinal direction X. Thus the winding densities of the coils 1, 2 vary in reverse of one another along the coil longitudinal direction X. In a preferred embodiment, a winding density (windings per coil volume) based on the coil volume can therefore remain constant in the coil longitudinal direction coil X, which is evident from the windings of the second coil 2 shown by way of example. In addition, in a further preferred embodiment, the total winding density of the coil arrangement, thus both coils 1, 2 together (windings per unit of length in the coil longitudinal direction X), may remain constant, in that the coils 1, 2 are wound in such a way that the winding density of the first coil 1 increases in the coil longitudinal direction X essentially to the same extent that the winding density of the second coil 2 decreases.

In the case of the embodiment according to FIG. 1, the winding density of the first and second coil 1, 2 respectively, changes in a linear manner in the coil longitudinal direction X. Thus, the change in the inductance of the first and second coil 1, 2 is substantially proportional to the position of the transducer element 3 along the coil longitudinal direction X. This makes a simple assessment of the position possible. The first coil 1 thereby has a substantially cone-shaped outer surface, while the second coil 2 has a substantially cone-shaped inner surface, which directly abuts the cone-shaped outer surface of the second coil 2.

In the case of the embodiment according to FIG. 2, the winding density of the first and second coil 1, 2 changes abruptly. The coils 1 2 each comprise different longitudinal sections 4 (in FIG. 2, each having a total of 4 longitudinal sections), within which sections the winding density in the coil longitudinal direction X remains constant. Each longitudinal section 4 has a different winding density as compared to the directly adjacent longitudinal section 4. When the transducer element 3 passes a transition U from one longitudinal section to another directly adjacent longitudinal section 4, the inductance of the coils 1, 2, changes abruptly as a result, which can be simply and clearly detected. Thus it can be very robustly determined at which transition U of the longitudinal sections 4 the transducer element 3 is currently located. In order to bring about a more refined detection of the position of the transducer element 3, a plurality of longitudinal sections 4, and thus transitions U, are provided.

An abrupt change in the winding density in the coil longitudinal direction X may also serve to constitute reference points. For example, in the case of the embodiment of the coil arrangement according to FIG. 1, an abrupt change in the winding density in the axial center of the coils 1, 2 may be provided in order to identify a center position of the transducer element 3, and to make it easy to detect that this center position has been reached. In this way, defined end positions or other defined reference points may also be optionally created.

In the case of the embodiment according to FIG. 3, the coils 1, 2 each comprise three longitudinal sections 4a, 4b, 4c, wherein the winding density in the first and third longitudinal section 4a, 4c changes in a linear manner, while the winding density in the second longitudinal section 4b remains constant. The winding density at each transition Ü between the longitudinal sections 4a, 4b, 4c is the same. Thus, in the case shown, the winding density at the transition Ü does not change abruptly. It may be provided, however, that the winding density changes abruptly at one or a plurality of transitions Ü. Since the winding density in the second longitudinal section 4b is constant, the inductance scarcely changes when the transducer element 3 is moved within the second longitudinal section 4b, it is made correspondingly more difficult to detect the position of the transducer element 3 in the longitudinal section 4b. Thus, through the specific distribution of longitudinal sections having a constant winding density and longitudinal sections having winding densities which vary, it is possible to create regions within which the determination of the position of the transducer element 3 is very precise, and it is possible to create regions within which the determination of the position of the transducer element 3 is less precise. In addition, as a result, the linearization of the sensor characteristic is made possible. This means that the inductance of the coil arrangement of the position sensor is a function of the position of the transducer element 3 with respect to the coil arrangement along the coil longitudinal direction X.

The coil arrangement according to FIG. 4 has a coil housing 5, which is magnetically conductive. As such, the magnetic flux inside the coil arrangement in the region of the transducer element 3 is significantly improved. The precision of the coil arrangement in determining the position of the transducer element 3 is thereby significantly increased. The coils 1, 2 in FIG. 4 correspond to those in FIG. 1. Naturally the housing 5 can be used in the case of any coil arrangement according to the invention, however, as is the case in the embodiment according to FIG. 2 or 3, for example. The housing 5 may also be specifically designed as a magnet yoke. In this way, a force on the transducer element that is generated by the magnetic field of the coils 1, 2 can be amplified or, respectively, produced when the coil arrangement is supplied with electrical power accordingly. The position sensor, which is formed from the coil arrangement and the transducer element 3, may serve as an actuator in that the magnetic force acting on the transducer element 3 is used to actuate a device such as a valve or a transmission shifting element in a motor vehicle, for example.

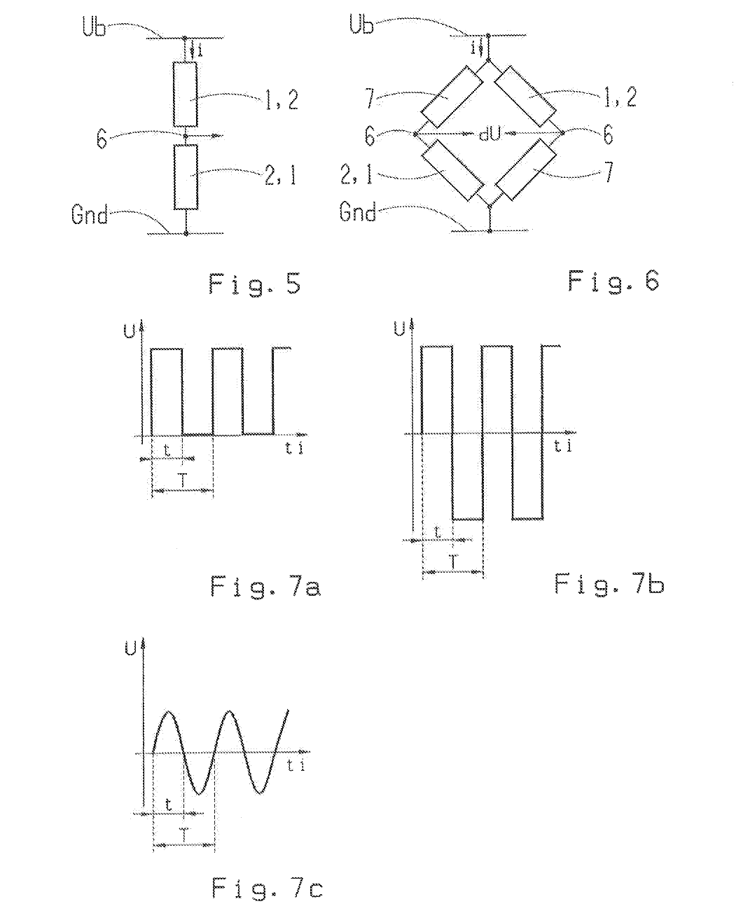

FIGS. 5 and 6 each show a preferred, electrically connected embodiment of the coil arrangement or, respectively, of the position sensor. In the embodiment according to FIG. 5, the two coils 1, 2 are electrically connected in series, one directly after the other, wherein a measuring tap 6, i.e., an electric measurement point, is provided between the coils. As such, the coils 1, 2, which are connected in series, are connected between two electrical potentials; in particular, a voltage source Ub and earth or ground Gnd. Thus, one of the coils 1, 2 is located between the measuring tap 6 and the voltage source Ub, and the other of the coils 1, 2 is located between the measuring tap 6 and earth or ground Gnd. An electric current, which flows between the coils 1, 2, is designated as i. The connection of the coil arrangement in series forms a voltage divider. Accordingly, the total voltage is divided between Ub and Gnd on the coils 1, 2, and is divided as a function of the electrical resistance of the coils. In the case that the coils 1, 2 are energized with a voltage pulse or, respectively, alternating voltage, the resistance is a function of the inductance of the respective coil 1, 2, which induction, in turn, is a function of the position of the transducer element 3 with respect to the coil arrangement. Thus the position of the transducer element 3 can be determined on the basis of the voltage potential at the measuring tap 6.

In the case of the embodiment according to FIG. 6, the coils 1, 2 are each connected to a comparator resistor 7 in series. One or both of the comparator resistors 7 may have a modifiable electrical resistance (ohmic resistance), for example, the resistor may be a potentiometer. The series connections of the comparator resistor 7 and coil 1, 2 are connected with one another in parallel between two electrical potentials; in particular, a voltage source Ub and earth or ground Gnd. Thus, each series connection comprising a comparator resistor 7 and a coil 1, 2, forms a separate leg of a so-called Wheatstone bridge circuit, wherein a measuring tap 6 is provided between each of the coils 1, 2 and the comparator resistor 7 connected in series therewith. In this way, the total electric current i flowing through the coil arrangement is divided into the two legs. A voltage divider is formed within each leg by the respective coil 1, 2 and the comparator resistor 7. Thus, similar to the embodiment from FIG. 5, a specific voltage potential develops at each measuring tap 6 as a function of the inductance of the coil 1, 2. The resulting voltage potential between the two measuring taps 6 is designated as dU. The position of the transducer element 3 with respect to the coil arrangement can then be determined on the basis of dU.

Insofar as one or both of the comparator resistors 7 have a modifiable electrical resistance, the resistance can be adjusted in such a way that dU essentially takes on the value zero (=no voltage potential between the measuring taps 6) and then, on the basis of the adjusted value of the resistance, the position of the transducer element 3 with respect to the coil arrangement can be determined. If necessary, there may be a plurality of voltage pulses in order to successively set dU closer to the value zero with each voltage pulse.

FIGS. 7a through 7c each show possible options for providing electrical current to (control of) the coil arrangement, such as the electrically connected coil arrangement according to FIG. 5 or 6, for example. The voltage U is plotted on the ordinate-axis, and the time ti is plotted on the abscissa-axis.

According to FIG. 7a, the coil arrangement is energized with a purely positive voltage, which has an essentially square temporal progression (positive square wave), thus with the steepest possible flanks. According to FIG. 7b, the coil arrangement is energized with an alternating voltage, which likewise has a square temporal progression, and according to FIG. 7c, the coil arrangement is energized with an alternating voltage that has a sinusoidal temporal progression. Alternatively, a sawtooth-shaped temporal progression of the voltage may also be selected. In addition, the voltage may be purely negative or purely positive, or may have alternating components. As a result, alternating components can be used to mitigate or even entirely eliminate the problem of magnetic remanence in the coils 1, 2 since the residual magnetic fields in the coils 1, 2 that remain in each period T after a voltage impulse in the coils 1, 2 can be mitigated or eliminated, at least in part, by a subsequent, opposite voltage impulse in the following period T.

The duty cycle of the voltage oscillations, thus the ratio between the pulse duration t and period duration T may be suitably selected. In the depicted case, the duty cycle is approximately 50%, however this is only provided by way of example.

FIGS. 8a through 8c depict preferred production steps for producing a coil arrangement according to the invention. In a first production step (FIG. 8a), the first coil 1 which forms the radially inner coil of the coil arrangement, is wound. In this case, an inner-most layer of windings is first helically wound along the coil longitudinal direction X, for example on a cylindrical carrier element (not shown), which either remains in the coil arrangement or is removed after production. FIG. 8a depicts by way of example a cross section of the first six rows of the first winding layer. The second layer of windings is subsequently helically wound along the coil longitudinal direction X in the direction opposite to that of the first layer, radially spaced apart from the first layer. Further winding layers are produced in an analogous manner; i.e., each layer is helically wound along the coil longitudinal direction X in the direction opposite to that of the immediately preceding winding layer. In so doing, the windings are disposed orthocyclically in order to achieve the greatest possible fill factor of the coils 1, 2.

The winding layers in the coil longitudinal direction X are designed such that they are of different lengths, depending on the way in which the winding density is intended to change in the coil longitudinal direction X (increasing abruptly, increasing in a linear manner, etc.). The length l of the winding layers of the first coil 1 continuously decreases; i.e., each winding layer is shorter by a specific amount than the immediately preceding winding layer, in order to achieve a linear increase in the winding density. In order to create a plurality of longitudinal sections each having the same winding densities, the length l of the winding layers decreases abruptly; i,e., for example, two or more immediately consecutive winding layers having an identical winding length are wound, and a third and a fourth winding layer which are identical to one another, however which are of a shorter length l than the first and second layer, are subsequently wound, as a result of which, a transition in the winding density is created at the shortened end of the third and fourth winding layer.

In the exemplary case shown in FIG. 8a, the winding density of the first coil 1 increases in a substantially linear manner. Thus, the length l of each individual winding layer is continuously shortened with respect to the immediately preceding layer until the desired number of windings or the desired outer diameter is reached.

In a second production step (FIG. 8b), the second coil 2, which forms the radially outer coil of the coil arrangement, is wound. To this end, an innermost layer of the windings is first helically wound along the coil longitudinal direction X. The second layer is then subsequently helically wound along the coil longitudinal direction X in the direction opposite that of the first layer, radially spaced apart from the first layer. Further winding layers are produced in an analogous manner; i.e., each layer is helically wound along the coil longitudinal direction X in the direction opposite to that of the immediately preceding winding layer. The windings are disposed orthocyclically in order to achieve the greatest possible fill factor. In contrast to the first coil 1, however, the winding length l of the second coil increases, and preferably increases to the same extent to which the winding length of the first coil 1 decreases. In addition, the winding of the layers of the second coil 2 is preferably done in such a way that the facing ends of the winding layers of the first and the second coil 1, 2 are directly in contact with one another. In this way, gaps in the coil arrangement are avoided and the fill factor is optimized. In order to obtain a coil arrangement that is as homogeneous as possible, and that has a high fill factor, the wires of the coils 1, 2 are designed such that they have an essentially identical thickness.

In a third production step (FIG. 8c), the two fully wound coils 1, 2 are electrically connected to one another. This may be done by creating an electrical contact between two adjacent free ends of the wires of the coils 1, 2 directly on the coil arrangement (by means of the interconnecting conductor 8), as depicted in FIG. 8c, or alternatively, may be done in such a way that the free ends of the wire of the coils 1, 2 are run electrically directly into an electronics assembly that is immediately adjacent or spaced apart therefrom, where the wires are electrically connected in accordance with the corresponding desired interconnection (see FIGS. 5 and 6), and, if applicable, connected to other electrical and/or electronic components.

It should be noted that the series connection of the coils 1, 2 depicted in FIG. 5 is obtained through the electrical connection of the coils 1, 2 by means of the interconnecting conductor 8 shown in FIG. 8c. The interconnecting conductor 8 is designed accordingly, such that an electrical contact can be made, in order to form the measuring tap 6 (indicated by the right arrow), while the remaining ends of the coil wires each having an electric potential are designed such that an electrical contact can be made (indicated by the left arrow).

The first, second and third production step are preferably temporally staggered in this sequence, thus the first step is preferably performed, then the second step, and finally the third. The production steps listed result in a simple and cost-effective production method for the coil arrangement according to the invention.

### REFERENCE CHARACTERS

1 first coil
2 second coil
3 transducer element
4, 4a-c longitudinal section
5 housing
6 measuring tap
7 comparator resistor
8 interconnecting conductor
dU resulting electrical voltage potential
Gnd electrical ground, earth
i electrical current
l length of a winding layer
t pulse duration
T period duration
ti time
U electrical voltage
Ub electrical voltage source
X coil longitudinal direction

1-13. (canceled)

14. A coil arrangement for a position sensor, the coil arrangement comprising:
a first coil (1),
a second coil (2),
the first coil (1) and the second coil (2) being electrically connected to one another and being disposed substantially coaxially relative to one another,
the first coil (1) having a winding density that increases in a longitudinal direction (X) of the coil arrangement, and
the second coil (2) having a winding density that decreases in the longitudinal direction (X) of the coil arrangement.

15. The coil arrangement according to claim 14, wherein the winding density of the first coil (1) increases in the longitudinal direction of the coil arrangement substantially to a same extent that the winding density of the second coil (2) decreases.

16. The coil arrangement according to claim 14, wherein the winding densities of the first coil and the second coil (2) change in a linear manner.

17. The coil arrangement according to claim 14, wherein the winding density of the first coil and the second coil (2) change abruptly in sections.

18. The coil arrangement according to claim 14, wherein the winding density of the first coil and the second coil (1, 2) change in a linear manner, in a first longitudinal section (4a), and are constant, in a second longitudinal section (4b) that adjoins the first longitudinal section (4a), and change in a linear manner, in a third longitudinal section (4c) that adjoins the second longitudinal section.

19. The coil arrangement according to claim 14, wherein the first coil and the second coil (2) are electrically connected in series, one directly after the other, with a measuring tap (6) located between the first coil and the second coil (1, 2).

20. The coil arrangement according to claim 14, wherein the first coil and the second coil (1, 2) are each connected in series with a comparator resistor (7), and each of the first coil and the second coil (1, 2), with the comparator resistor (7) connected in series, forms a leg of a Wheatstone bridge circuit, and
a measuring tap (6) is arranged between each of the first coil and the second coil (1, 2) and the comparator resistor (7) connected in series thereto.

21. The coil arrangement according to claim 14, wherein a magnetically conductive housing (5) is provided, within which the first coil and the second coil (1, 2) are disposed, to magnetically influence magnetic flux within the coil arrangement.

22. A coil arrangement (1, 2) in combination with a position sensor, the coil arrangement comprising:
a first coil (1),
a second coil (2),
the first coil (1) and the second coil (2) being electrically connected to one another and being disposed substantially coaxially relative to one another,
the first coil (1) having a winding density that increases in a longitudinal direction (X) of the coil arrangement,
the second coil (2) having a winding density that decreases in the longitudinal direction (X) of the coil arrangement,
a magnetically conductive transducer element (3) being a position feedback transducer and being disposed with respect to the coil arrangement to move along the longitudinal direction (X) of the coil arrangement.

23. The position sensor according to claim 22, wherein the coil arrangement (1, 2) is designed as circular segments, along the longitudinal direction (X), and the transducer element (3) is movable at least in circular segments along the coil arrangement (1, 2), as an angle-position transducer so that the position sensor forms an angle-position sensor.

24. The position sensor according to claim 22, wherein the coil arrangement (1, 2) is straight, in the longitudinal direction, and the transducer element is movable, in a linear manner, along the longitudinal axis of the coil arrangement (1, 2) as a linear position feedback transducer so that the position sensor forms a linear position sensor.

25. A method for producing a coil arrangement for a position sensor which has a first coil (1) and a second coil (2), which are electrically connected to one another and disposed substantially coaxially relative to one another, the first coil (1) has a winding density that increases in a longitudinal direction (X) of the coil arrangement, and the second coil (2) has a winding density that decreases in the longitudinal direction (X) of the coil arrangement, the method comprising:
winding the first coil (1) as a radially inner coil
winding the second coil (2) as a radially outer coil, and
electrically connecting the first coil (1) to the second coil (2).

26. The method according to claim 14, further comprising winding of the second coil (2) such that opposite ends of winding layers of the first coil and the second coil (1, 2) are directly in contact with one another.
